(19) United States
(12) Patent Application Publication
(10) Pub. No.: US 2016/0091055 A1
(43) Pub. Date: Mar. 31, 2016

(54) HYBRID TRANSMISSION FOR VEHICLE

(71) Applicant: Hyundai Motor Company, Seoul (KR)

(72) Inventors: Baek Yu Kim, Suwon-si (KR); Sung Gon BYUN, Anyang-si (KR); Seok Joon KIM, Yongin-si (KR); Chul Min AHN, Busan (KR)

(73) Assignee: Hyundai Motor Company, Seoul (KR)

(21) Appl. No.: 14/616,180

(22) Filed: Feb. 6, 2015

(30) Foreign Application Priority Data
Sep. 29, 2014 (KR) 10-2014-0129966

(51) Int. Cl. F16H 3/085

(52) U.S. Cl. CPC F16H 3/085; F16H 2003/0826

(57) ABSTRACT

A hybrid transmission for a vehicle may include an input shaft installed such that power of an engine is transferred to the input shaft, a plurality of driving gears provided on the input shaft to restrict rotation thereof, first and second output shafts having a plurality of driven gears engaged to the plurality of driving gears, respectively, to form a plurality of gear shift stages, motor driving gears, motors connected to the motor driving gears for allowing torque to be applied to the motor driving gears, a starting clutch unit provided to enable the motor driving gears to be connected to or disconnected from the input shaft, EV1 and EV2 driven gears engaged to the motor driving gears and rotatably installed on the first and second output shafts, respectively, an EV1 synchronizer, an EV2 synchronizer, and an engine clutch.

### CROSS-REFERENCE(S) TO RELATED APPLICATIONS

The present application claims priority to Korean Patent Application Number 10-2014-0129966 filed Sep. 29, 2014, the entire contents of which is incorporated herein for all purposes by this reference.

### BACKGROUND OF THE INVENTION

1. Field of the Invention

Various aspects of the present invention relate to a hybrid transmission for a vehicle, particularly, to a transmission structure technique for enabling realization of various traveling modes through a simple configuration and improvement in shift quality.

2. Description of Related Art

An AMT (Automated Manual Transmission) may realize both of convenience of a conventional automatic transmission for automatically shifting gears according to traveling states of a vehicle without a driver's operation, and high power transfer efficiency realized by a conventional manual transmission.

However, the AMT based on a conventional manual transmission mechanism necessarily cuts off power transferred to drive in a process of releasing a previous gear shift stage and shifting to a next gear shift stage during gear shifting. For this reason, there is a problem in that a shift shock occurs.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a hybrid transmission for a vehicle, capable of improving shift quality by preventing power to a drive wheel from being completely cut off in a gear shifting process and of realizing various traveling modes through a simple configuration so that a vehicle has an improved fuel efficiency by effective traveling suitable for traveling conditions of the vehicle.

According to various aspects of the present invention, a hybrid transmission for a vehicle includes an input shaft installed such that power of an engine is transferred to the input shaft, a plurality of driving gears provided on the input shaft so as to restrict rotation thereof, first and second output shafts having a plurality of driven gears engaged to the plurality of driving gears, respectively, to form a plurality of gear shift stages, motor driving gears rotatably installed on the input shaft, motors connected to the motor driving gears for allowing torque to be applied to the motor driving gears, a starting clutch unit provided so as to enable the motor driving gears to be connected to or disconnected from the input shaft, EV1 and EV2 driven gears engaged to the motor driving gears and rotatably installed on the first and second output shafts, respectively, an EV1 synchronizer installed so as to enable the EV1 driven gear to be connected to or disconnected from the first output shaft, an EV2 synchronizer installed so as to enable the EV2 driven gear to be connected to or disconnected from the second output shaft, and an engine clutch provided so as to enable the input shaft to be connected to or disconnected from the engine.

The motors may be coaxially installed on the input shaft.

The driven gears of the first output shaft, which are engaged with the driving gears of the input shaft to form the gear shift stages, may be arranged so as to form a relatively low stage of a series of gear shift stages, and the driven gears of the second output shaft may be arranged so as to form a relatively high stage of the gear shift stages.

A first driven gear, a second driven gear, and a third driven gear may be rotatably installed on the first output shaft, the hybrid transmission may be provided with a first & second synchronizer for allowing rotation of the first or second driven gear to be restricted or the rotation restriction thereof to be released, with respect to the first output shaft, and the hybrid transmission may be provided with a third synchronizer for allowing rotation of the third driven gear to be restricted or the rotation restriction thereof to be released, with respect to the first output shaft.

A fourth driven gear, a fifth driven gear, and a sixth driven gear may be rotatably installed on the second output shaft, the hybrid transmission may be provided with a fourth & fifth synchronizer for allowing rotation of the fourth or fifth driven gear to be restricted or the rotation restriction thereof to be released, with respect to the second output shaft, and the hybrid transmission may be provided with a sixth synchronizer for allowing rotation of the sixth driven gear to be restricted or the rotation restriction thereof to be released, with respect to the second output shaft.

The starting clutch unit may include a starting synchro mechanism which is a synchronizer having a hub provided on the input shaft.

The input shaft may have driving gears including a first driving gear, a second driving gear, and a third driving gear.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram illustrating a realization example of a hybrid transmission for a vehicle according to an exemplary embodiment of the present invention.

FIG. 2 is a diagram illustrating a state in which a first speed in EV mode is realized by the transmission in FIG. 1.

FIG. 3 is a diagram illustrating a state in which a second speed in EV mode is realized by the transmission in FIG. 1.

FIG. 4 is a diagram illustrating a state in which an engine is started by the transmission in FIG. 1.

FIG. 5 is a diagram illustrating a state in which a first speed in HEV1 mode is realized by the transmission in FIG. 1.

FIG. 6 is a diagram illustrating a state in which a second speed in HEV1 mode is realized by the transmission in FIG. 1.

FIG. 7 is a diagram illustrating a state in which a third speed in HEV1 mode is realized by the transmission in FIG. 1.

FIG. 8 is a diagram illustrating a state in which a fourth speed in HEV1 mode is realized by the transmission in FIG. 1.

FIG. 9 is a diagram illustrating a state in which a first speed in HEV2 mode is realized by the transmission in FIG. 1.

FIG. 10 is a diagram illustrating a state in which a second speed in HEV2 mode is realized by the transmission in FIG. 1.

FIG. 11 is a diagram illustrating a state in which a third speed in HEV2 mode is realized by the transmission in FIG. 1.

FIG. 12 is a diagram illustrating a state in which a fourth speed in HEV2 mode is realized by the transmission in FIG. 1.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

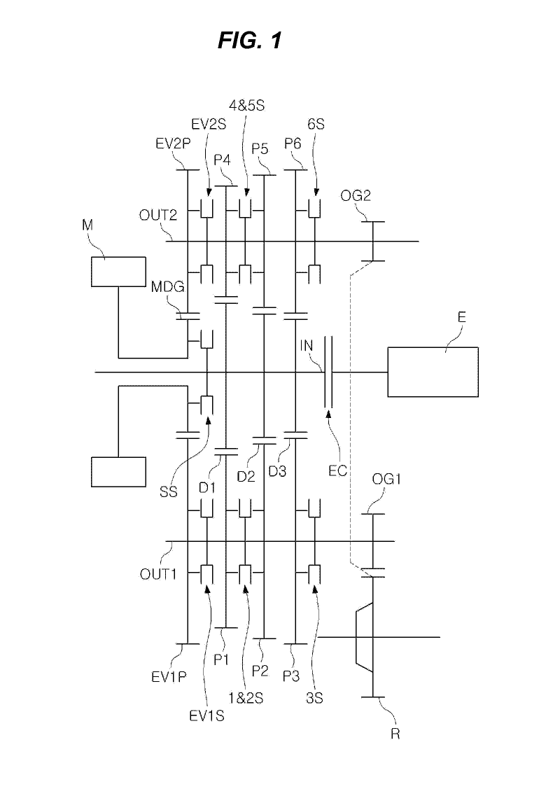

Referring to FIG. 1, a hybrid transmission for a vehicle according to various embodiments of the present invention includes an input shaft IN installed such that power of an engine E is transferred to the input shaft IN, a plurality of driving gears provided on the input shaft IN so as to restrict rotation thereof, first and second output shafts OUT1 and OUT2 having a plurality of driven gears which are respectively engaged to the plurality of driving gears to form a plurality of gear shift stages, motor driving gears MDG which are rotatably installed to the input shaft IN, a motor M connected to the motor driving gears MDG for allowing torque to be applied to the motor driving gears MDG, a starting clutch unit provided so as to enable the motor driving gears MDG to be connected to or disconnected from the input shaft IN, EV1 and EV2 driven gears EV1P and EV2P which are engaged to the motor driving gears MDG and rotatably installed to the first and second output shafts OUT1 and OUT2, respectively, an EV1 synchronizer EV1S installed so as to enable the EV1 driven gear EV to be connected to or disconnected from the first output shaft OUT1, an EV2 synchronizer EV2S installed so as to enable the EV2 driven gear EV2P to be connected to or disconnected from the second output shaft OUT2, and an engine clutch EC provided so as to enable the input shaft IN to be connected to or disconnected from the engine E.

That is, in the hybrid transmission, in a state in which a plurality of gear shift stages are formed between the input shaft IN driven by power transferred from the engine E and the first and second output shafts OUT1 and OUT2, the motor driving gears MDG connected to the motors M are switched between a rotatable state and a rotation restriction state with respect to the input shaft IN and torques of the motor driving gears MDG are transferred to the first and second output shafts OUT1 and OUT2 and the EV1 and EV2 driven gears EV1P and EV2P, respectively. Thereby, power generated by the motors M may be taken off through the first and second output shafts OUT1 and OUT2.

Of course, the power may be transferred to drive wheels in such a manner that the first output shaft OUT1 is provided with a first output gear OG1, the second output shaft OUT2 is provided with a second output gear OG2, and the first and second output gears OG1 and OG2 are simultaneously engaged to a differential ring gear R.

In various embodiments, the motors M are coaxially installed to the input shaft IN. In addition, the input shaft has the driving gears configured of a first driving gear D1, a second driving gear D2, and a third driving gear D3.

In various embodiments, the driven gears of the first output shaft OUT1, which are engaged with the driving gears of the input shaft IN to form the gear shift stages, are arranged so as to form a relatively low stage of a series of gear shift stages, and the driven gears of the second output shaft OUT2 are arranged so as to form a relatively high stage of the gear shift stages.

That is, a first driven gear P1, a second driven gear P2, and a third driven gear P3 are rotatably installed to the first output shaft OUT1. The hybrid transmission is provided with a first & second synchronizer 1&2S for allowing rotation of the first or second driven gear P1 or P2 to be restricted or the rotation restriction thereof to be released, with respect to the first output shaft OUT1. The hybrid transmission is provided with a third synchronizer 3S for allowing rotation of the third driven gear P3 to be restricted or the rotation restriction thereof to be released, with respect to the first output shaft OUT1.

A fourth driven gear P4, a fifth driven gear P5, and a sixth driven gear P6 are rotatably installed to the second output shaft OUT2. The hybrid transmission is provided with a fourth & fifth synchronizer 4&5S for allowing rotation of the fourth or fifth driven gear P4 or P5 to be restricted or the rotation restriction thereof to be released, with respect to the second output shaft OUT2. The hybrid transmission is provided with a sixth synchronizer 6S for allowing rotation of the sixth driven gear P6 to be restricted or the rotation restriction thereof to be released, with respect to the second output shaft OUT2.

Meanwhile, in various embodiments, the starting clutch unit is configured of a starting synchro mechanism SS which is a synchronizer having a hub provided on the input shaft IN.

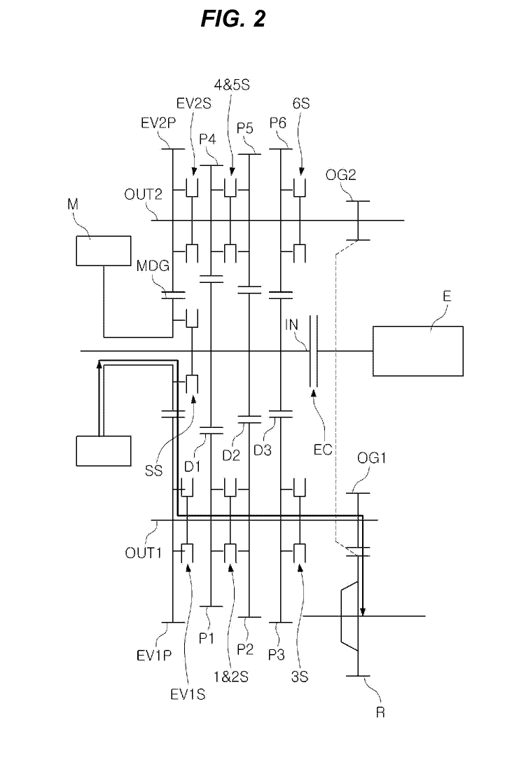

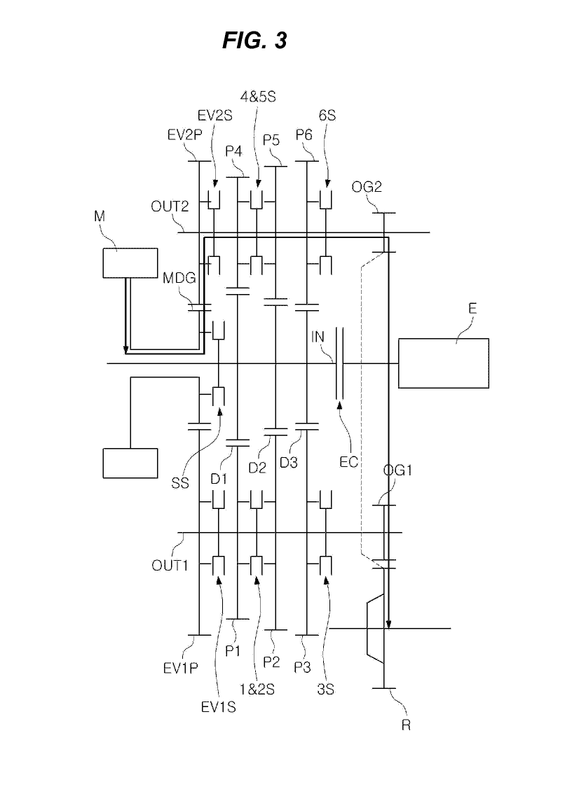

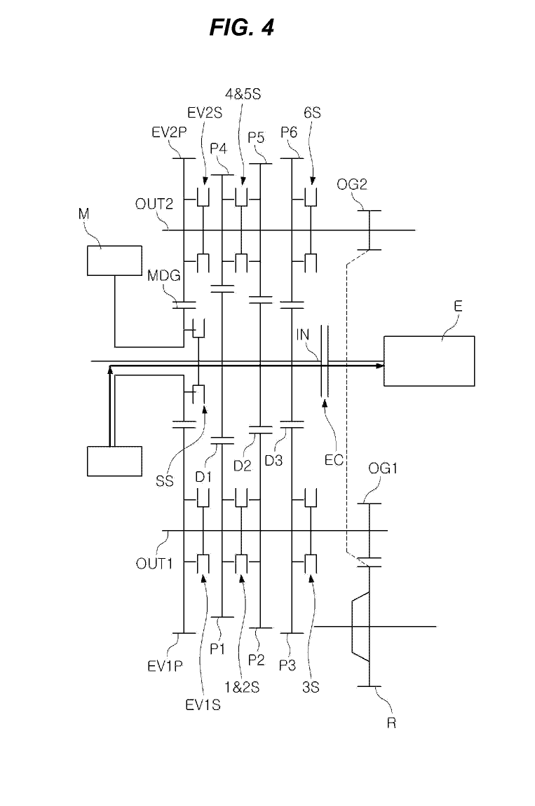

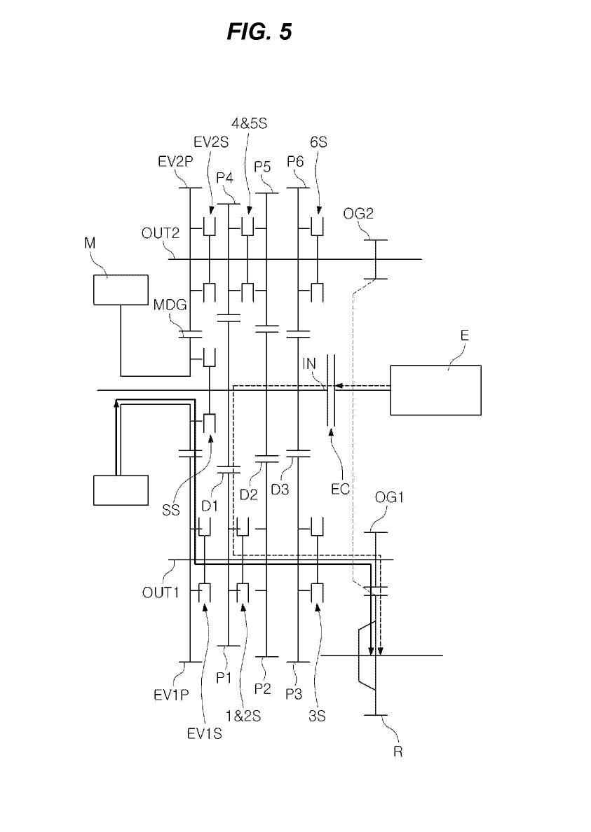

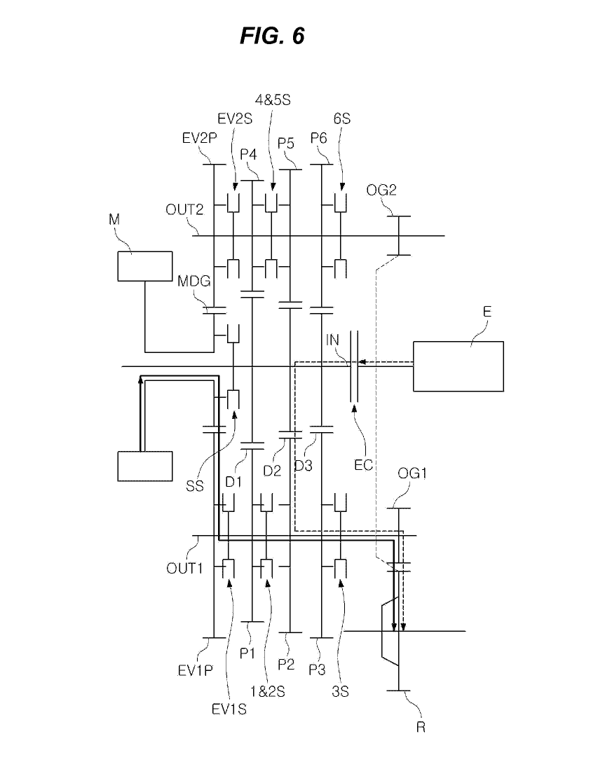

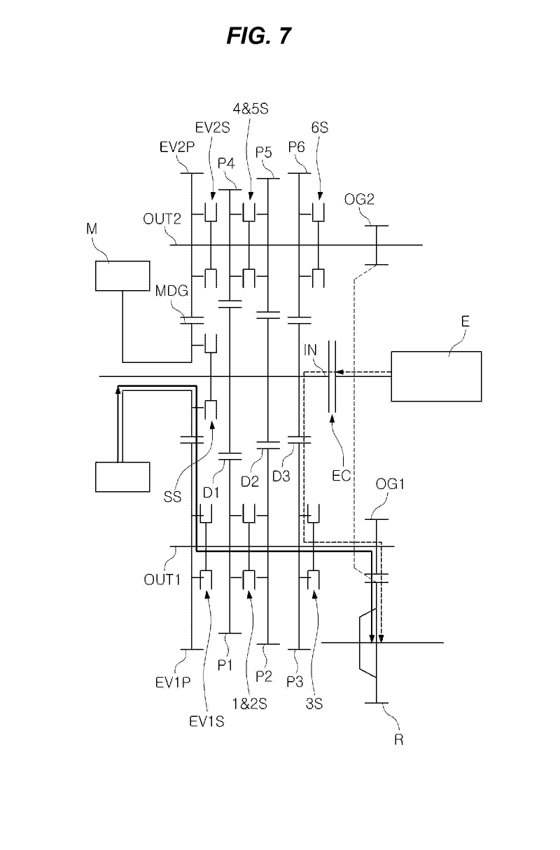

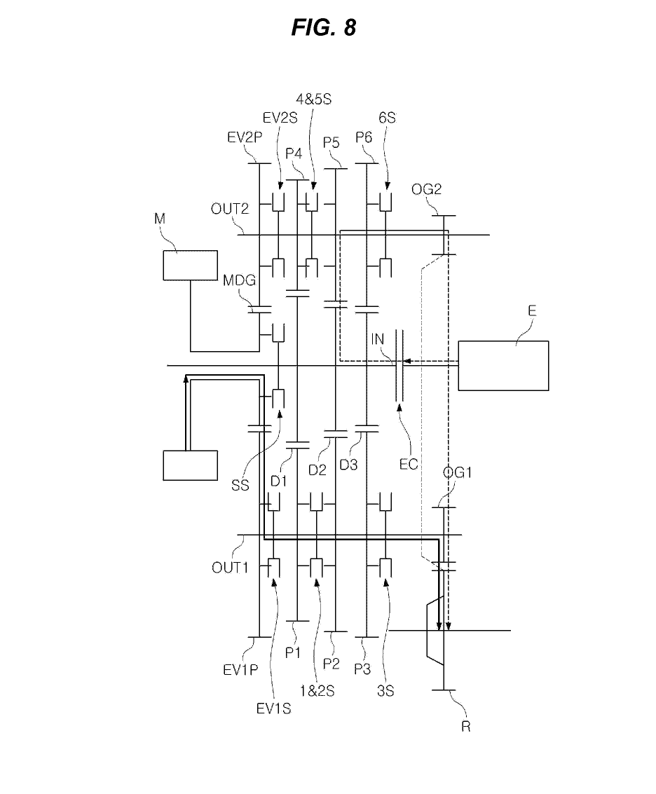

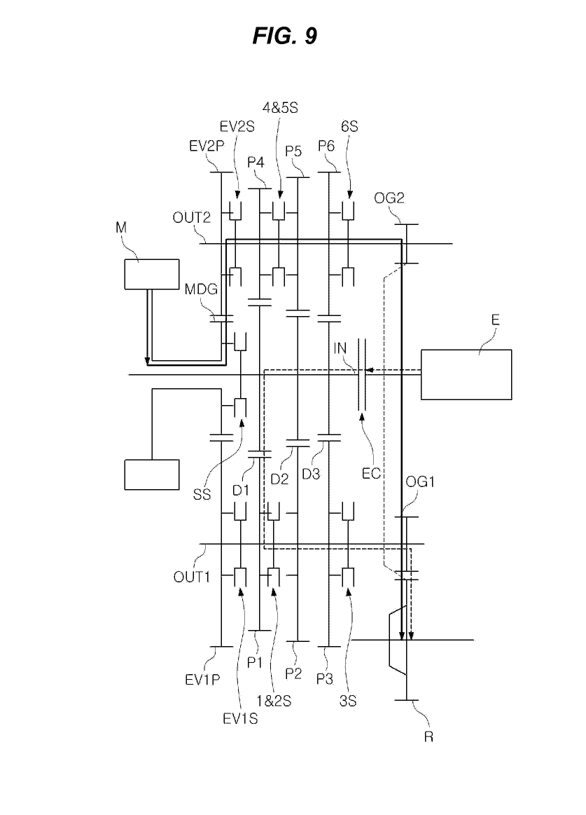

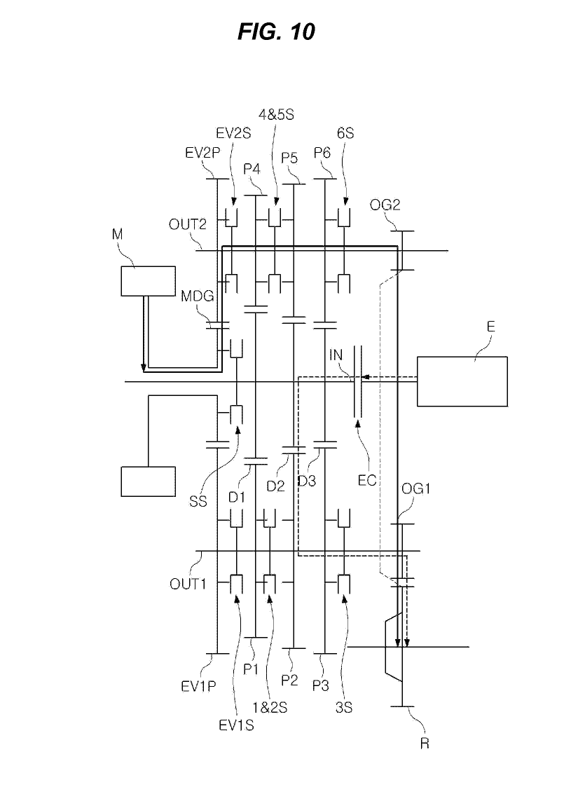

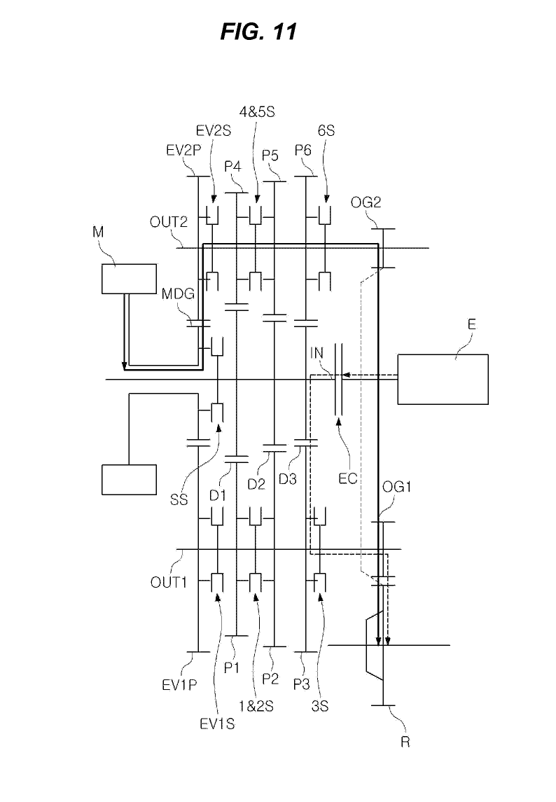

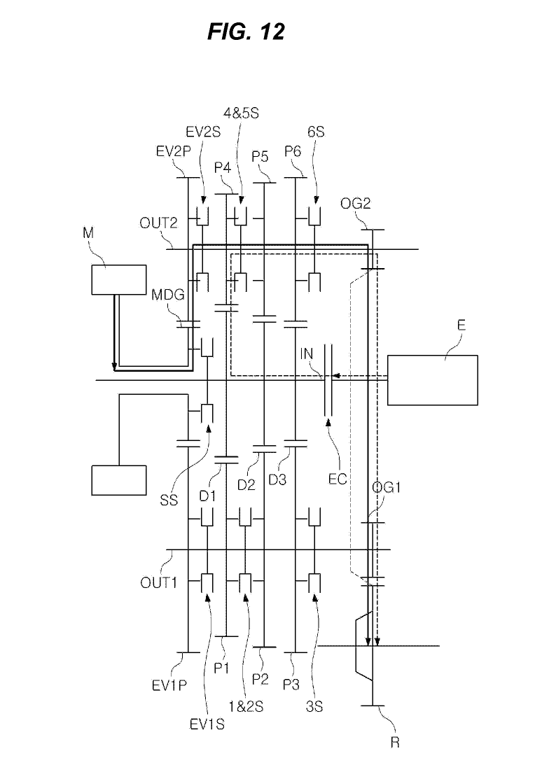

Hereinafter, operations of the various embodiments of the present invention will be described with reference to FIG. 2, FIG. 3, FIG. 4, FIG. 5, FIG. 6, FIG. 7, FIG. 8, FIG. 9, FIG. 10, FIG. 11, and FIG. 12.

FIG. 2 shows a state of a first speed in EV mode. In FIG. 2, when the motor M is driven in a state in which the rotation of the EV1 driven gear EV1P is restricted with respect to the first output shaft OUT1 by the EV1 synchronizer EV1S, the power of the motor M is shifted between the motor driving gear MDG and the EV1 driven gear EV1P to be taken off to the differential ring gear R through the first output shaft OUT1.

FIG. 3 shows a state of a second speed in EV mode. In FIG. 3, when the motor M is driven in a state in which the rotation of the EV2 driven gear EV2P is restricted with respect to the second output shaft OUT2 by the EV2 synchronizer EV2S, the power of the motor M is taken off to the differential ring gear R through the second output shaft OUT2.

FIG. 4 is a diagram for explaining a state in which an engine is started. In FIG. 4, the power of the motor M is transferred to the engine E through the motor driving gear MDG, the input shaft IN, and the engine clutch EC by coupling of the starting synchro mechanism SS to the engine clutch EC, and thus the engine E is started.

FIG. 5 shows a state of a first speed in HEV1 mode. In FIG. 5, the power of the engine E and the power of the motor M are provided together in a state in which the engine clutch EC is coupled to the engine E, the rotation of the EV1 driven gear EV1P is restricted with respect to the first output shaft OUT1 by the EV1 synchronizer EV1S, and the rotation of the first driven gear P1 is restricted with respect to the first output shaft OUT1 by the first and second synchronizer 1 and 2S. Consequently, the power of the engine E is coupled to the power of the motor M in the first output shaft OUT1 so that the coupled power is taken off to the ring gear.

FIG. 6 shows a state of a second speed in HEV1 mode. The state shown in FIG. 6 differs from the state shown in FIG. 5 only in that the rotation of the second driven gear P2, instead of the first driven gear P1, is restricted with respect to the first output shaft OUT1 by the first and second synchronizer 1&2S. In FIG. 6, the power of the engine E is joined with the power of the motor M in the first output shaft OUT1 through the second driven gear P2.

FIG. 7 shows a state of a third speed in HEV1 mode. The case shown in FIG. 7 is realized in such a manner that the rotation of the third driven gear P3 is restricted with respect to the first output shaft OUT1 by the third synchronizer 3S, instead of the first & second synchronizer 1&2S, while the rotation restriction state of the EV1 driven gear EV1P with respect to the first output shaft OUT1 by the EV1 synchronizer EV1S is maintained.

FIG. 8 shows a state of a fourth speed in HEV1 mode. In FIG. 8, the rotation of the fourth driven gear P4 is restricted with respect to the second output shaft OUT2 by the fourth & fifth synchronizer 4&5S, instead of the third synchronizer 3S, while the rotation restriction state of the EV1 driven gear EV1P with respect to the first output shaft OUT1 by the EV1 synchronizer EV1S is maintained. Consequently, the power of the engine E is transferred to the ring gear R through the second output shaft OUT2 and the power of the motor M is transferred to the ring gear R through the first output shaft OUT1, so that the power joined in the ring gear R is taken off to the drive wheels.

Moreover, a case of fifth and sixth speeds in HEV1 mode is realized similar to those described above. The case of the fifth speed in HEV1 mode is realized in such a manner that the fourth & fifth synchronizer 4&5S connects the fifth driven gear P5 to the second output shaft OUT2 while the rotation restriction state of the EV1 driven gear EV1P with respect to the first output shaft OUT1 by the EV1 synchronizer EV1S is maintained. The case of the sixth speed in HEV1 mode is realized in such a manner that the sixth synchronizer 6S connects the sixth driven gear P6 to the second output shaft OUT2 While the rotation restriction state of the EV1 driven gear EV1P with respect to the first output shaft OUT1 by the EV1 synchronizer EV1S is maintained.

FIG. 9 shows a state of a first speed in HEV2 mode. In FIG. 9, the engine clutch EC is coupled to the engine E in a state in which the rotation of the EV2 driven gear EV2P is restricted with respect to the second output shaft OUT2 by the EV2 synchronizer EV2S and the rotation of the first driven gear P1 is restricted with respect to the first output shaft OUT1 by the first & second synchronizer 1&2S. Consequently, the power of the engine E is transferred to the ring gear R through the first output shaft OUT1 and the power of the motor M is transferred to the ring gear R through the EV2 driven gear EV2P and the second output shaft OUT2.

FIG. 10 shows a state of a second speed in HEV2 mode. In FIG. 10, the rotation of the second driven gear P2 is restricted with respect to the first output shaft OUT1 by the first & second synchronizer 1&2S and the engine clutch EC is coupled to the engine E in a state in which the rotation of the EV2 driven gear EV2P is restricted with respect to the second output shaft OUT2 by the EV2 synchronizer EV2S. Consequently, the power of the engine E and the power of the motor M are joined in the differential ring gear R and are taken off

FIG. 11 shows a state of a third speed in HEV2 mode. In FIG. 11, the engine clutch EC is coupled to the engine E in a state in which the rotation of the EV2 driven gear EV2P is restricted with respect to the second output shaft OUT2 by the EV2 synchronizer EV2S and the rotation of the third driven gear P3 is restricted with respect to the first output shaft OUT1 by the third synchronizer 3S. Consequently, the power of the engine E and the power of the motor M are joined in the differential ring gear R.

FIG. 12 shows a state of a fourth speed in HEV2 mode. In FIG. 12, the rotation of the fourth driven gear P4 is restricted with respect to the second output shaft OUT2 by the fourth & fifth synchronizer 4&5S and the engine clutch EC is coupled to the engine E while the rotation restriction state of the EV2 driven gear EV2P with respect to the second output shaft OUT2 by the EV2 synchronizer EV2S is maintained. Consequently, both of the power of the engine E and the power of the motor M are joined in the second output shaft OUT2, and the joined power is taken off to the differential ring gear R through the second output gear OG2.

Moreover, a case of fifth and sixth speeds in HEV2 mode is realized similar to those described above. The case of the fifth speed in HEV2 mode is realized in such a manner that the rotation of the fifth driven gear P5 is restricted with respect to the second output shaft OUT2 by the fourth & fifth synchronizer 4&5S in a state in which the engine clutch EC is coupled to the engine E and the rotation of the EV2 driven gear EV2P is restricted with respect to the second output shaft OUT2 by the EV2 synchronizer EV2S. The case of the sixth speed in HEV2 mode is realized in such a manner that the rotation of the sixth driven gear P6 is restricted with respect to the second output shaft OUT2 by the sixth synchronizer 6S in a state in which the engine clutch EC is coupled to the engine E and the rotation of the EV2 driven gear EV2P is restricted with respect to the second output shaft OUT2 by the EV2 synchronizer EV2S.

In the various embodiments as described above, for example, when the state of the first speed in HEV1 mode shown in FIG. 5 is shifted to the state of the fourth speed in HEV1 mode shown in FIG. 8, the engine clutch EC is released from the engine E and the rotation restriction state of the first driven gear P1 with respect to the first output shaft OUT1 by the first & second synchronizer 1&2S is released in a state in which the power transfer state of the motor M through the EV1 driven gear EV1P, the EV1 synchronizer EV1S, and the first output shaft OUT1 is maintained. Then, the shift is performed in such a manner that the rotation of the fourth driven gear P4 is restricted with respect to the second output shaft OUT2 by the fourth & fifth synchronizer 4&5S and the engine clutch EC is coupled to the engine E.

The driving force by the motor M is continuously transferred to the drive wheels during the gear shifting, and thus deterioration of shift quality caused by power cut-off during the gear shifting may be prevented.

Of course, the above-mentioned control method may be used in the shift between other gear shift stages, and thus it may be possible to secure smooth and stable shift quality and traveling quality of the vehicle without power cut-off with respect to the drive wheels.

Meanwhile, a modification example may be made in which the transmission has a simpler inner structure by excluding the starting synchro mechanism SS as the starting clutch unit and mounting a separate motor for performing only starting of the engine E to the engine E in various embodiments.

In accordance with a hybrid transmission for a vehicle according to various embodiments of the present invention, it may be possible to improve shift quality by preventing power to a drive wheel from being completely cut off in a gear shifting process and to realize various traveling modes through a simple configuration so that a vehicle has an improved fuel efficiency by effective traveling suitable for traveling conditions of the vehicle.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A hybrid transmission for a vehicle, comprising:
an input shaft installed such that power of an engine is transferred to the input shaft;
a plurality of driving gears provided on the input shaft to restrict rotation thereof;
first and second output shafts having a plurality of driven gears engaged to the plurality of driving gears, respectively, to form a plurality of gear shift stages;
a motor driving gear rotatably installed on the input shaft;
a motor connected to the motor driving gear for allowing torque to be applied to the motor driving gears;
a starting clutch unit configured to enable the motor driving gear to be connected to or disconnected from the input shaft;
EV1 and EV2 driven gears engaged to the motor driving gear and rotatably configured on the first and second output shafts, respectively;
an EV1 synchronizer configured to enable the EV1 driven gear to be connected to or disconnected from the first output shaft;
an EV2 synchronizer configured to enable the EV2 driven gear to be connected to or disconnected from the second output shaft; and
an engine clutch configured to enable the input shaft to be connected to or disconnected from the engine.

2. The hybrid transmission of claim 1, wherein the motor is coaxially installed on the input shaft.

3. The hybrid transmission of claim 1, wherein,
the driven gears of the first output shaft, which are engaged with the driving gears of the input shaft to form the gear shift stages, are arranged to form a relatively low stage of a series of gear shift stages, and
the driven gears of the second output shaft are arranged to form a relatively high stage of the gear shift stages.

4. The hybrid transmission of claim 3, further including:
a first driven gear, a second driven gear, and a third driven gear rotatably configured on the first output shaft;
a first and second synchronizer for allowing rotation of the first or second driven gear to be restricted or the rotation restriction thereof to be released, with respect to the first output shaft; and
a third synchronizer for allowing rotation of the third driven gear to be restricted or the rotation restriction thereof to be released, with respect to the first output shaft.

5. The hybrid transmission of claim 3, further including:
a fourth driven gear, a fifth driven gear, and a sixth driven gear rotatably configured on the second output shaft;
a fourth and fifth synchronizer for allowing rotation of the fourth or fifth driven gear to be restricted or the rotation restriction thereof to be released, with respect to the second output shaft; and
a sixth synchronizer for allowing rotation of the sixth driven gear to be restricted or the rotation restriction thereof to be released, with respect to the second output shaft.

6. The hybrid transmission of claim 1, wherein the starting clutch unit includes a starting synchro mechanism which is a synchronizer having a hub provided on the input shaft.

7. The hybrid transmission of claim 2, wherein the input shaft has driving gears including a first driving gear, a second driving gear, and a third driving gear.
